(19) United States
(12) Patent Application Publication
(10) Pub. No.: US 2022/0307728 A1
(43) Pub. Date: Sep. 29, 2022

(54) AIR SELF-CIRCULATION UNPOWERED HEATING DEVICE AND SUBGRADE THEREOF

(71) Applicant: Northwest Institute of Eco-Environment and Resources, Chinese Academy of Sciences, Lanzhou (CN)

(72) Inventors: Qihao YU, Lanzhou (CN); Kun CHEN, Lanzhou (CN); Xinbin WANG, Lanzhou (CN)

(21) Appl. No.: 17/582,218

(22) Filed: Jan. 24, 2022

(30) Foreign Application Priority Data
Mar. 25, 2021 (CN) 202110321521.7

(51) Int. Cl. F24S 20/64; F24S 10/90; E01C 3/06

(52) U.S. Cl. CPC F24S 20/64; F24S 10/90; E01C 3/06

(57) ABSTRACT

An air self-circulation unpowered heating device includes a heat collection header mounted outside a subgrade, a solar heat absorption box having one end inserted into the heat collection header for absorbing solar energy and transferring heat to the heat collection header, and a heat gathering tube comprising a heat absorption section and a heat release section in communication. The heat absorption section is inserted into the heat collection header for absorbing heat of the heat collection header and transferring heat to the heat release section, and the heat release section is inserted into the subgrade for heating the subgrade.

### CROSS-REFERENCE TO RELATED APPLICATIONS

This non-provisional application claims priority under 35 6U.S.C. § 119(a) on Patent Application No. 202110321521.7 filed in P.R. China on Mar. 25, 2021, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “Prior Art” to the present invention described herein. All references listed, cited and/or discussed in this specification are incorporated herein by reference in their entireties and to the same extent as if each reference was individually incorporated by reference.

### FIELD OF THE INVENTION

The present invention relates to the technical field of engineering construction in a seasonal frozen-soil region, and particularly to an air self-circulation unpowered heating device and subgrade thereof.

### BACKGROUND OF THE INVENTION

In China western seasonal frozen-soil region, due to the influence of low temperature and environmental change in winter, at a certain depth of surface layer, the soil body is frozen in winter and completely melted in warm and other seasons, which is referred to as seasonal frozen-soil in geocryology. For example, in a region surrounding Qinghai Lake in the middle of Qinghai province, the average temperature in the coldest January is −20.6° C., and the maximum frozen depth may reach 1.8 m, which belongs to a typical seasonal frozen-soil region. Such regions are at places of coastal plains, alluvial plains, ice platforms, and the like, and have a shallow water table, and subgrades around Qinghai-Tibet highway and Qinghai-Tibet railway have large moisture content. Since 9% expansion in volume occurs after water is frozen, it causes frost heave of the subgrades after freezing. As freezing and melting circulations cause lifting and sinking of pavement or track of the subgrade, it forms an important influence on the stability of the subgrade, and constitutes an important threat to traffic safety, causing freeze-thaw hazard of the subgrade.

As for this problem, methods such as replacement of coarse particles, chemical grouting, and waterproof curtain in the common regions are difficult to satisfy actual engineering needs, due to limitations of engineering conditions such as normal driving of trains without interruption of construction, and crack at processing positions and extreme difficulty in an overall enclosure at a lower part of the subgrade caused by strong action of freeze-thawing of soil body in the seasonal frozen-soil region. It is a feasible method by heating the subgrade and preventing freezing of the subgrade, but due to weak study in the existing technology, novel measures suitable for actual conditions of sites and satisfying actual needs are still lacking. Some existing measures heat the subgrade by using solar energy, but due to the influence of factors such as low working efficiency, use of electric power, and a too-high expense, it is difficult to satisfy actual working conditions and actual needs in the wild sites.

### SUMMARY OF THE INVENTION

An object of the invention includes providing an air self-circulation unpowered heating device and subgrade thereof, which can take advantage of solar energy resources, and realize balanced and flat heating of the subgrade by flat heating of the ground temperature field of the subgrade and key regulation of positions prone to frost heave in the subgrade, thereby effectively avoiding engineering diseases such as frost heave and uneven fluctuation of the subgrade in the seasonal frozen-soil region.

In a first aspect, the invention provides an air self-circulation unpowered heating device, comprising:
a heat collection header mounted outside a subgrade;
a solar heat absorption box having one end inserted into the heat collection header for absorbing solar energy and transferring heat to the heat collection header; and
a heat gathering tube comprising a heat absorption section and a heat release section in communication, wherein the heat absorption section is inserted into the heat collection header for absorbing the heat of the heat collection header and transferring heat to the heat release section, and the heat release section is inserted into the subgrade for heating the subgrade.

In such a way, the solar heat absorption box absorbs solar energy and transfers heat to the heat collection header, the heat absorption section of the heat gathering tube absorbs the heat of the heat collection header and transfers heat to the heat release section, and the heat release section heats the subgrade, such that the subgrade is always in pure heat absorption, and internal heat is continuously accumulated, thereby reaching heat gathering inside the subgrade and a state where the temperature is always held to be positive, and reaching objects of freezing of the subgrade, frost heave of the subgrade and engineering diseases.

In an optional embodiment, the heat collection header and the solar heat absorption box are filled with air, and one end of the solar heat absorption box inserted into the heat collection header is provided with an opening, which is for air convection between the solar heat absorption box and the heat collection header.

In such a way, the solar heat absorption box transfers heat to the heat absorption section in the heat collection header using air convection, such that heat transfer efficiency is high, and the requirement for airtightness of the heat collection header and the solar heat absorption box is not too high, thereby reducing design difficulty and production cost, and improving the stability of the device without obviously reducing the performance of the device even if leakage occurs.

In an optional embodiment, the solar heat absorption box is inserted into a middle-lower portion of the heat collection header, and the heat absorption section is inserted into a middle-upper portion of the heat collection header.

In such a way, under the principle that a density of hot air is less than that of cold air, hot air in the solar heat absorption box can automatically rise to the heat absorption section to heat the heat absorption section, the above cold air in the heat collection header automatically falls, and is heated to hot air via the solar heat absorption box, hot air rises again, and in such way, circulation is performed, thereby improving heating efficiency of the heat absorption section.

In an optional embodiment, an angle between a length direction of the solar heat absorption box and a horizontal plane is within a range from 0° to 20°, and one end of the solar heat absorption box inserted into the heat collection header is higher than the other end.

In such a way, the flow of hot air inside the solar heat absorption box to the heat collection header at a higher position can be accelerated, and the flow of cold air in the heat collection header to the solar heat absorption box is also accelerated. Moreover, the center of gravity of the solar heat absorption box may also be lowered, and the stability of the device is improved.

In an optional embodiment, the solar heat absorption box comprises:
a housing having one end inserted into the heat collection header provided with an opening, which is for air convection between the housing and the heat collection header;
a heat preservation layer disposed on an inner wall of the housing;
a transparent cover plate mounted at a top of the housing; and
solar heat absorption bars mounted at a bottom of the housing for absorbing solar energy and heating air in the housing.

In such a way, the solar heat absorption bars can improve the heating efficiency of air in the solar heat absorption box, and the heat preservation layer can reduce the loss of heat in the solar heat absorption box.

In an optional embodiment, a plurality of solar heat absorption bars are evenly arranged along a length direction of the solar heat absorption box at an interval, and an upward-lifting angle of the solar heat absorption bars relative to a bottom surface of the housing is a preset angle.

In an optional embodiment, the preset angle is within a range from 10° to 45°.

In an optional embodiment, a heat absorption surface of the solar heat absorption bars is perpendicular to an irradiation direction of solar rays when solar radiation is strongest in winter of this region.

In such a way, firstly, the heat absorption surface of the solar heat absorption bars substantially can be directly irradiated by sunlight, the total area of the heat absorption surface is larger, and the efficiency of absorbing solar energy is higher. Secondly, the heat absorption surface and a back surface of the solar heat absorption bars can heat air in the solar heat absorption box, and the efficiency of heating the air is higher.

In a second aspect, the invention provides an air self-circulation unpowered heating subgrade, comprising a subgrade and the air self-circulation unpowered heating device according to any of the previous embodiments, wherein the heat collection header and the solar heat absorption box are mounted outside the subgrade, and the heat release section is inserted into the subgrade.

In such a way, heat is gathered inside the subgrade, and temperature is always held in a positive state, thereby reaching objects of preventing and treating freezing of the subgrade, frost heave of the subgrade, and engineering diseases.

In an optional embodiment, the air self-circulation unpowered heating subgrade further comprises a heat preservation material layer disposed on a slope of the subgrade.

In such a way, the heat preservation material layer can prevent loss of heat inside the subgrade, and effectively ensures reservation of heat inside the subgrade in the process of day-night change.

### BRIEF DESCRIPTION OF THE DRAWINGS

To clearly explain the technical solution in the embodiment of the invention, hereinafter the desired accompanying drawings in the embodiment are simply introduced. It shall be understood that hereinafter the drawings only illustrate some examples of the invention, so it shall not be viewed as a definition to the scope. As for those ordinary in the art, on the premise of making no creative work, other relevant drawings may also be obtained based on these drawings.

FIG. 1 is a structural diagram of an air self-circulation unpowered heating subgrade provided in one embodiment of the invention.

FIG. 2 is a structural diagram of an air self-circulation unpowered heating device in FIG. 1.

FIG. 3 is a top view of the structure in FIG. 2.

FIG. 4 is a right view of the structure in FIG. 2.

FIG. 5 is a sectional diagram of the structure in FIG. 2.

FIG. 6 is a sectional diagram of a solar heat absorption box in FIG. 1.

FIG. 7 is a schematic diagram of a ground temperature field of stimulation calculating results after the subgrade is laid with heat gathering tubes for thirty days.

### DETAILED DESCRIPTION OF THE PREFERRED EMBODIMENT

To make objects, technical solutions, and advantages of the embodiments of the invention clearer, hereinafter the technical solution in the embodiments of the invention is clearly and completely described with reference to the drawings in the embodiments of the invention. Obviously, the described embodiments are a part of the embodiments of the invention, not all embodiments. Generally, components in the embodiments of the invention described and illustrated in the drawings can be arranged and designed in various configurations.

Therefore, detailed descriptions of the embodiments of the invention provided in the drawings do not aim to limit the scope protected by the invention, but only represent the selected embodiments of the invention. Based on the embodiments in the invention, on the premise of making no creative work, all other embodiments obtained by those ordinary in the art belong to the scope protected by the invention.

It shall be noticed that similar reference signs and letters represent similar items in the drawings, so once one item is defined in one drawing, it is unnecessary to make further definition and explanation in subsequent drawings.

In the descriptions of the invention, it shall be noted that if orientation or positional relation indicated by terms “up”, “down”, “in” and “out” is an orientation or positional relation illustrated based on the drawings, or commonly placed orientation or positional relation when the invention products are used, it is only to facilitate describing the invention and simplifying the descriptions, not indicating or suggesting that the device or element must have a specific orientation, and is constructed and operated in a specific orientation, so the invention is not limited thereto.

It shall be noted that in the case of not conflicting, features in the embodiments of the invention can be combined.

Therefore, concerning the problems described in the background, the embodiment of the invention provides a novel structure, which realizes a positive temperature state of the subgrade in the whole winter and prevention and treating influence of freeze-thawing of the subgrade by efficiently taking advantage of solar and unpowered heat transfer through continuous heat gathering of the subgrade based on the entire heat transfer process of the subgrade. Moreover, the structure also prominently solves the problem of circulation power desired in the heating process of the subgrade.

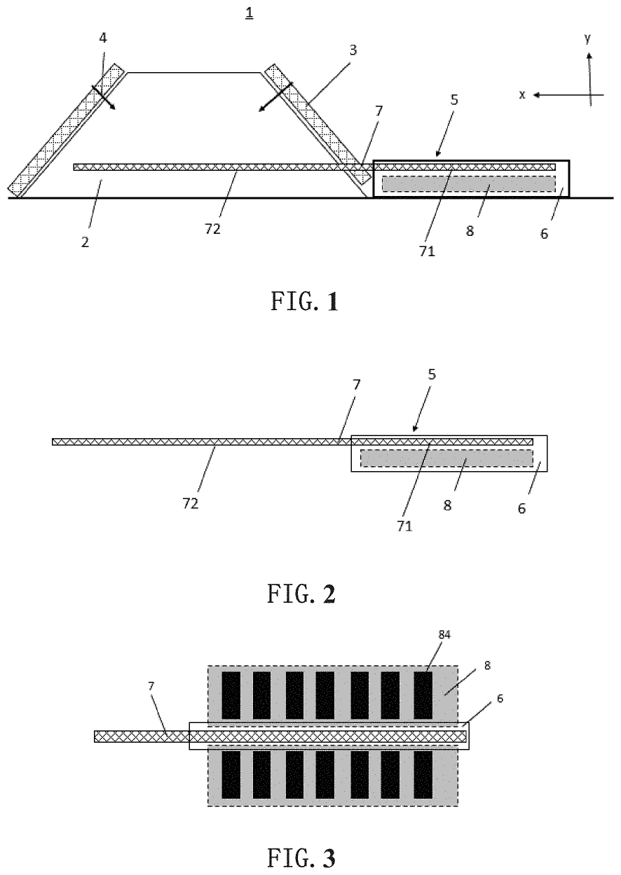

Referring to FIG. 1, an air self-circulation unpowered heating subgrade 1 comprises a subgrade 2, a heat preservation material layer 3, and an air self-circulation unpowered heating device 5.

The heat preservation material layer 3 is disposed on a slope of the subgrade 2, covers the entire slope of the subgrade 2, and is fixed by an anchor rod 4. In other embodiments, the heat preservation material layer 3 may also be compacted and fixed by covering a thin layer of soil or other material on an outer surface of the heat preservation material layer 3. The heat preservation material layer 3 may be composed of building rock wool heat preservation material or an integrated heat preservation plate. Specifically, the sunny slope and the shady slope of the subgrade 2 may be provided with the heat preservation material layer 3, thereby preventing loss of heat inside the subgrade 2, and effectively ensuring the reservation of heat inside the subgrade 2 in the process of day-night change.

Specifically, referring to FIGS. 1 to 5, the air self-circulation unpowered heating device 5 comprises a heat collection header 6, a solar heat absorption box 8, and a heat gathering tube 7. The heat collection header 6 can be disposed in a natural surface region close to a foot of the sunny slope of the subgrade 2, and may also be disposed in a natural surface region of the shady slope of the subgrade 2 where the sun can irradiate in winter.

The heat gathering tube 7 is a special-shaped heat tube. The heat gathering tube 7 comprises a heat absorption section 71 and a heat release section 72 in communication, wherein the heat absorption section 71 is inserted into the heat collection header 6, and the heat collection header 6 and the heat absorption section 71 form a sealed chamber. The heat release section 72 is inserted into the subgrade 2 between a half and a foot of the slope of the subgrade 2, and an insertion direction is perpendicular to a length direction of the subgrade 2. The length of the heat gathering tube 7 may be determined according to the actual conditions of sites. The heat absorption section 71 absorbs the heat of the heat collection header 6 and transfers heat to the heat release section 72, and the heat release section 72 heats the subgrade 2. An angle between the heat-gathering tube 7 and a horizontal plane is within a range from −30° to 30°. In other words, as shown in FIG. 1, an angle of the heat gathering tube 7 between extension along a direction x and upward lifting along a direction y is within a range from 0° to 30°, or downward inclining along a direction y is within a range from −30° to 0°. In this embodiment, preferably, an upward-lifting angle of the heat release section 72 of the heat gathering tube 7 relative to the heat absorption section 71 is within a range from 5° to 10°, such that the heat release section 72 is across most of a width of the subgrade 2, and a height of the heat release section 72 is at a middle-lower position of the subgrade 2. In such a way, it is convenient to mount the heat gathering tube 7 in the subgrade 2, a drilling depth is small, and the number of drillings is few, with an original engineering structure of the subgrade 2 unchanged, thereby ensuring the stability of the original subgrade 2, having no influence on normal driving of the trains during construction, and effectively solving difficulties in engineering construction when satisfying the condition of driving of the trains. Moreover, liquid-absorbing cores are arranged inside the heat gathering tube 7, and the heat absorption section 71 has a certain height difference from the heat release section 72, so under the action of gravity and a capillary force, the effect of horizontal heat tubes is easily achieved, and efficient transfer of heat in a horizontal direction is implemented, thereby realizing unpowered efficient heat transfer of the whole device.

Referring to FIG. 3, the solar heat absorption box 8 is arranged on two opposite sides of the heat collection header 6, the heat collection header 6 and the solar heat absorption box 8 are filled with air, and one end of the solar heat absorption box 8 inserted into the heat collection header 6 is provided with an opening, which is for air convection between the housing 81 and the heat collection header 6. Moreover, the solar heat absorption box 8 and the heat collection header 6 form a sealed structure. The heat collection header 6 and the solar heat absorption box 8 transfer heat by using air, such that a heat transfer efficiency is high, and the requirement for airtightness of the heat collection header 6 and the solar heat absorption box 8 is not too high, thereby reducing design difficulty and production cost, and improving the stability of the device without obviously reducing the performance of the device even if leakage occurs.

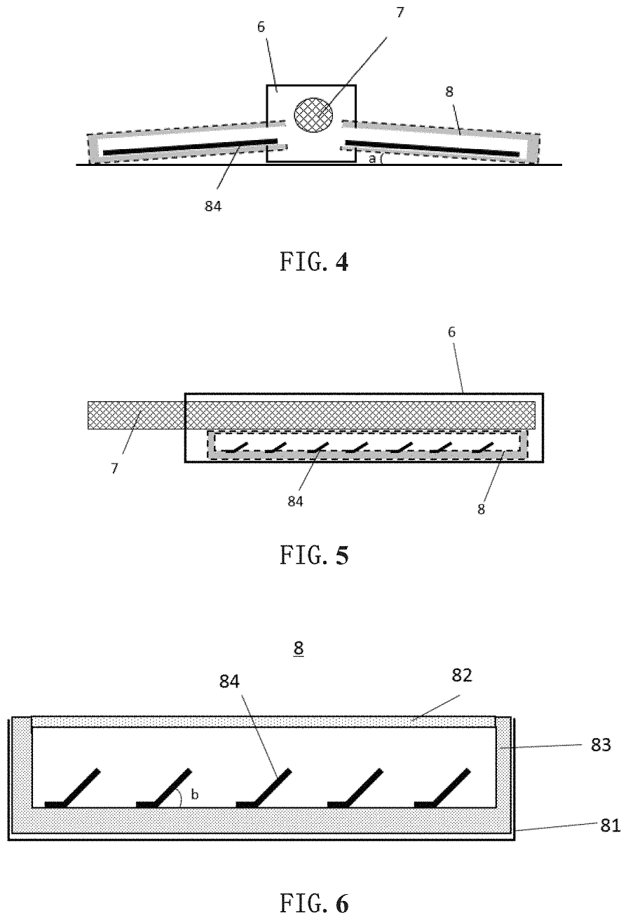

Referring to FIG. 4, the solar heat absorption box 8 is inserted into a middle-lower portion of the heat collection header 6, and the heat absorption section 71 is inserted into a middle-upper portion of the heat collection header 6. An angle between the solar heat absorption box 8 and a horizontal plane is within a range from 0° to 20°, and one end of the solar heat absorption box 8 inserted into the heat collection header 6 is higher than the other end. In such a way, under the principle that a density of hot air is less than that of cold air, hot air in the solar heat absorption box 8 can automatically rise to the heat absorption section 71 of the heat collection header 6 to heat the heat absorption section 71, flow of hot air inside the solar heat absorption box 8 to the heat collection header 6 at a higher position can be accelerated, and flow of cold air in the heat collection header 6 to the solar heat absorption box 8 is also accelerated, such that cold air is heated to hot air through the solar heat absorption box 8, hot air rises again, and in such way, circulation is performed, thereby improving heating efficiency of the heat absorption section 71. Moreover, the center of gravity of the solar heat absorption box 8 may also be lowered, and the stability of the device is improved.

Referring to FIGS. 3 to 6, the solar heat absorption box 8 comprises a housing 81 having one end inserted into the heat collection header 6 provided with an opening, which is provided for air convection between the housing 81 and the heat collection header 6, a heat preservation layer 83 disposed on an inner wall of the housing 81, a transparent cover plate 82 mounted at a top of the housing 81, and solar heat absorption bars 84 mounted at a bottom of the housing 81 for absorbing solar energy and heating air in the housing 81. In such a way, the solar heat absorption bars 84 can improve the heating efficiency of air in the solar heat absorption box 8, and the heat preservation layer 83 can reduce the loss of heat in the solar heat absorption box 8.

Specifically, referring to FIG. 6, the solar heat absorption bars 84 are made of a good metal conductor, and the thickness of the solar heat absorption bars 84 can be within a range from 0.5 mm to 3 mm. A plurality of solar heat absorption bars 84 are evenly arranged along a length direction of the solar heat absorption box 8 at an interval. One end of the solar heat absorption bars 84 is fixedly connected to a bottom surface of the housing 81, and an upward-lifting angle of the other end relative to the bottom surface of the housing 81 is a preset angle b, which is within a range from 10° to 45°. A solar energy-absorbing coating can be disposed on a heat absorption surface, and uses a solar energy-efficient absorption material, particularly, an electrodeposited coating and an electrochemical surface conversion coating, which can efficiently absorb solar energy, and converts it into heat energy.

Most preferably, the heat absorption surface of the solar heat absorption bars 84 is perpendicular to an irradiation direction of solar rays when solar radiation is strongest in winter of this region. In such a way, firstly, the heat absorption surface of the solar heat absorption bars 84 substantially can be directly irradiated by sunlight, a total area of the heat absorption surface is larger, and the efficiency of absorbing solar energy is higher. Secondly, the heat absorption surface and a back surface of the solar heat absorption bars 84 can heat air in the solar heat absorption box 8, and the efficiency of heating the air is higher.

Therefore, an inclined angle of the solar heat absorption bars 84 can be set according to the solar elevation angle in winter of the local region to satisfy that the solar heat absorption bars 84 are substantially perpendicular to irradiation rays of sunlight at noon of winter. Under the condition of irradiation in winter, the solar heat absorption bars 84 receive solar radiation to the maximum extent and absorb heat most efficiently. In warm seasons, since the solar elevation angle is increased, many rays are irradiated onto gaps between the heat absorption bars, so the overall absorbing efficiency of solar radiation is reduced. Accordingly, the adverse effect of strong solar radiation in different seasons, in particular, warm seasons, on overheating of the system is controlled.

The advantage of the solar heat absorption bars 84 further lies in a hanging design. After the solar heat absorption bars 84 absorb radiation to be heated, two lateral surfaces of the solar heat absorption bars 84 can become heating surfaces to heat surrounding air, and efficiency is far higher than the design of laying metallic heat absorption materials on the entire bottom surface of the housing 81 with only one heating surface to air, while also saving use of the heat absorption materials.

The working principle of the air self-circulation unpowered heating device and subgrade thereof provided in this embodiment is as follows:

Under the condition of solar radiation, the solar heat absorption bars 84 in the solar heat absorption box 8 start absorbing heat, the temperature rises rapidly to heat surrounding air, and under the action of a buoyancy force and pushing, the heated air rises and moves to inside of the heat collection header 6 along a top of the solar heat absorption box 8, and heats the heat absorption section 71 of the heat gathering tube 7. After heat release, as a density is increased, air with a reduced temperature falls and moves into the solar heat absorption box 8, and is heated in the solar heat absorption box 8. Accordingly, circulation is performed, and heat inside the solar heat absorption box 8 is continuously transferred to the heat absorption section 71 of the heat gathering tube 7, and finally transferred to inside of the subgrade 2 through the heat release section 72 of the heating gathering tube, thereby reaching the object of heating the frozen subgrade 2 through air self-circulation.

As compared to the existing engineering technology, the air self-circulation unpowered heating device and subgrade thereof provided in this embodiment at least have the following advantages:

1. As compared to the existing grouting engineering technology, in the air self-circulation unpowered heating device and subgrade thereof provided in this embodiment, firstly, the heat gathering tube extends inside the subgrade from the lower part of the subgrade in a substantially horizontal direction, mainly covers most of regions at a bottom of the subgrade, and as compared to drilling holes vertically downward in the existing grouting engineering, the number of drilling holes and a depth of the drilling holes can be reduced; secondly, the existing grouting engineering changes engineering structure of the subgrade, while this embodiment is mainly to regulate a ground temperature for changing thermal properties of the subgrade, and mainly functions in regions with rich water and an expanded volume after frost heave in the subgrade, while not changing the original engineering structure of the subgrade; finally, the existing grouting engineering does not use the heat preservation material layer, while in this embodiment, the heat preservation material layer can prevent loss of heat inside the subgrade, and effectively ensure reservation of heat inside the subgrade in the process of day-night change;

2. As compared to the existing electric heating engineering technology, the existing electric heating engineering heats the subgrade through electric heating measures inside the subgrade, needs supply from external power, and requires building and laying of special electric power lines, so large electric power resources are consumed every year, and when an internal electronic electric heating system has fault under wild use conditions, cost of operation and maintenance is large. By contrast, the air self-circulation unpowered heating device and subgrade thereof provided in this embodiment do not have an external power source, and circulate automatically, and realize the object of heating the subgrade by taking full advantage of local rich solar energy resources, so they save energy sources, and are green and environmental protective.

To sum up, as compared to the existing engineering technology, the air self-circulation unpowered heating device and subgrade thereof provided in this embodiment have notable progress and control freeze-thaw key elements in diseases of the subgrade in the seasonal frozen-soil region, thereby obtaining double results, also realizing horizontal, balanced and symmetrical distribution of ground temperature isolines of the subgrade, eliminating influence on a difference of thermodynamic coupling of the subgrade, and further enhancing the stability of a mechanical field of the subgrade. These effectively avoid engineering diseases such as uneven frost heave and longitudinal crack of the subgrade, in particular, the wide subgrade, and ensure long-term stability of the subgrade, so the embodiment of the invention has prominent scientific and advancement.

In an aspect of construction, this embodiment solves difficulties in existing engineering construction. The construction position in this embodiment is one side or both sides of the subgrade, and the construction method is drilling holes horizontally. Point construction is carried out on the subgrade, the speed of filling and drilling in the subgrade is fast, and the diameter of the holes is small, so the stability of the subgrade is not affected. Moreover, during construction, it is only to drill holes and insert into holes, while having no measures such as grouting and replacement, so it won't produce disturbance in a large range and change of mechanical properties to the subgrade, thereby further ensuring the stability of the original subgrade. The construction process does not constitute influence on normal driving of the trains and realizes the requirements for engineering construction under the condition of driving of the trains.

In an aspect of stability, in this embodiment, the heat collection header and the solar heat absorption box use a manner of connecting those with a suitable height, low, wide, and large in series, which increases the stability of the whole device in China western strong wind and harsh environment. Moreover, lowering the center of gravity of the heating units helps the formation and increase of a pushing force in the entire thermal circulation of the device, and ensures smooth and efficient working during the whole circulation and heat transfer.

More advantageously, the solar heat absorption bars are designed to be an upwarp structure, such that under the condition of absorbing heat and a high temperature in solar radiation, the solar heat absorption bars heat surrounding air through two lateral surfaces, and further enhance the overall heat-absorbing effect through the effective increase of a heat dissipation area as compared to commonly laying the solar heat absorption panel only at the bottom of the solar heat absorption box.

To verify regulation efficiency of the air self-circulation unpowered heating device and subgrade thereof provided in the embodiments of the invention, numerical modeling, and simulation calculation under the action of engineering measures are performed combining with geological conditions of the test engineering sites of Qinghai-Tibet Railway from Xining to Golmud.

Example: on one side of a shady slope of the subgrade for Qinghai-Tibet Railway with a height of 2.0 m and a top width of 7.5 m, the heat release section of the heat gathering tubes are horizontally inserted inside the subgrade at a position of a height of 0.5 m, the heat release section has a length of 8 m, and an interval of the heat gathering tubes along a length direction of the subgrade is 2 m. In the heating system, the heating power is 900 W with reference to the heating power of the existing 1 m² heat gathering cover in such region, working time is from 10 am to 4 pm in the daytime, and effective power is discounted and calculated by 50%. To further verify the effectiveness of such measures in adverse conditions, the heat preservation material layer is not laid on the slope of the subgrade in simulation calculation.

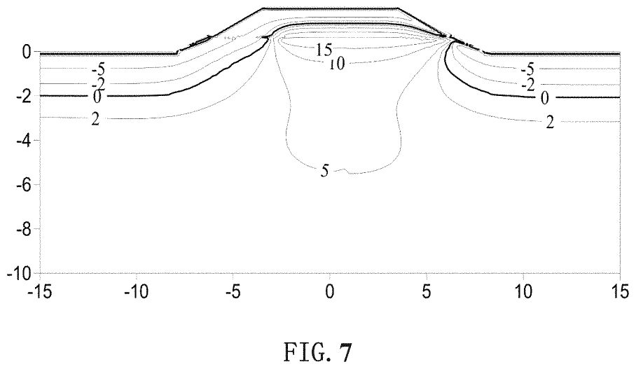

Under such working conditions, the heat gathering tubes were set on December 15, and on January 15 of this winter, a ground temperature field of simulation calculating results after the heat gathering tubes were laid for several days was shown in FIG. 7. FIG. 7 is a ground temperature profile of the subgrade under the condition of the lowest external environmental temperature at 8:30 am after the subgrade on the 30th day performs heat dissipation of one night. As can be seen, (a) in an aspect of features of ground temperature values, the ground temperatures in most regions of the subgrade are in a positive state, and the ground temperatures at positions of a supporting layer and having higher moisture of the lower part of the subgrade are in a relatively high-temperature region, wherein the maximum temperature may reach 18° C.; (b) in an aspect of characteristics of morphology of the ground temperature field, the ground temperature isolines represent horizontal and parallel morphological characteristics as a whole. In particular, the 0° C. isothermal line is distributed flat, i.e., the frozen zone and the positive temperature zone are in parallel to each other. The frozen zone has the only distribution of a few thin lines at an upper part of the subgrade, and distribution is even and symmetrical, so engineering difficulties of the frozen-soil can be effectively solved, and details are as follows:

(1) it improves the state of the temperature field in a center region of the original subgrade and satisfies the requirements for regulation of the temperature field of the railway subgrade in the seasonal frozen-soil region. As can be seen from FIG. 7, after implementation of this detailed embodiment, the ground temperatures in the central region and the main supporting layer of the subgrade are in the positive state, and positive temperature and high-temperature soil cores are formed in the center of the subgrade. Moreover, since this part of the soil body has a high moisture content, a large thermal capacity, and more gathered heat, the capability of frost heave prevention of the subgrade is improved when the external environmental temperature is reduced;

(2) distribution of 0° C. ground temperature isoline and other isothermal lines in the temperature field is completely horizontal and flat, and distribution of thin lines in the frozen zone is at a top of the subgrade and close to a revetment, which largely improves the stability of the subgrade. As can be seen from FIG. 7, the temperature field of the subgrade is distributed flat, in particular, 0° C. isothermal line, and is convex upwardly as a whole in the subgrade, thereby facilitating discharging of water in the subgrade, and significantly reducing frost heave amount of the subgrade at a stage where atmospheric precipitation and freeze-thawing are frequently alternated in early Spring;

(3) it eliminates the influence of the shady-sunny slope effect and substantially eliminates the engineering disease of a longitudinal crack in the subgrade. As can be seen from FIG. 7, the temperature field of the subgrade beneath the pavement is substantially distributed symmetrically around a center of the subgrade, and the isothermal lines in the temperature field of the subgrade are distributed flat, as well as distribution of the frozen zone only at a top of the subgrade and a thin strip region under the revetment, which further weakens less transverse differential frost heave amount produced at a part of frozen positions, and further eliminates the possibility of a longitudinal crack of the subgrade.

This embodiment is only for representative analyses for the invention, and the conclusion substantially represents the effects to be achieved by the invention in tendency (different in specific values).

In addition, simulation calculation shows that when the railway is built in the seasonal frozen-soil region according to the structure provided in this embodiment, the frozen-soil subgrade always stores heat energy during operation, and the frozen zone in the subgrade is reduced along with an operating time, so the structure can satisfy the desired requirements for mechanical stability of the subgrade, and may sustain long-term stability of the subgrade.

The above disclosures are only detailed embodiments of the invention, but the protection scope of the invention is not limited thereto. Easily conceivable change or substitution for any skilled in the art within the technical range disclosed by the invention shall be covered within the protection scope of the invention. Therefore, the protection scope of the invention shall be subjected to the scope protected by the appended claims.

1. An air self-circulation unpowered heating device, comprising:
a heat collection header mounted outside a subgrade;
a solar heat absorption box having one end inserted into the heat collection header for absorbing solar energy and transferring heat to the heat collection header; and
a heat gathering tube comprising a heat absorption section and a heat release section in communication, wherein the heat absorption section is inserted into the heat collection header for absorbing heat of the heat collection header and transferring heat to the heat release section, and the heat release section is inserted into the subgrade for heating the subgrade.

2. The air self-circulation unpowered heating device according to claim 1, wherein the heat collection header and the solar heat absorption box are filled with air, and the one end of the solar heat absorption box inserted into the heat collection header is provided with an opening air convection between the sol absorption box and the heat collection header.

3. The air self-circulation unpowered heating device according to claim 1, wherein the solar heat absorption box is inserted into a middle-lower portion of the heat collection header, and the heat absorption section is inserted into a middle-upper portion of the heat collection header.

4. The air self-circulation unpowered heating device according to claim 1, wherein the between a length direction of the solar heat absorption box and a horizontal plane is within a range from 0° to 20°, and the one end of the solar heat absorption box inserted into the heat collection header is higher than the other end.

5. The air self-circulation unpowered heating device according to claim 1, wherein the solar heat absorption box comprises.
a housing having one end inserted into the heat collection header and provided with an opening for air convection between the housing and the heat collection header;
a heat preservation layer disposed on an inner wall of the housing;
a transparent cover plate mounted at a top of the housing; and
solar heat absorption bars mounted at a bottom of the housing for absorbing solar energy and heating air in the housing.

6. The air self-circulation unpowered heating device according to claim 5, wherein a plurality of the solar heat absorption bars are arranged along length direction of the solar heat absorption box at an even interval, and an upward-lifting angle of the solar heat absorption bars relative to a bottom surface of the housing is a preset angle.

7. The air self-circulation unpowered heating device according to claim 6, wherein the preset angle is within a range from 10° to 45°.

8. The air self-circulation unpowered heating device according to claim 6, wherein a heat absorption surface of the solar heat absorption bars is perpendicular to an irradiation direction of solar rays when solar radiation is strongest in winter of this region.

9. An air self-circulation unpowered heating subgrade, comprising a subgrade and the air self-circulation unpowered heating device according to claim 1, wherein the heat collection header and the solar heat absorption box are mounted outside the subgrade, and the heat release section is inserted into the subgrade.

10. The air self-circulation unpowered heating subgrade according to claim 9, wherein the air self-circulation unpowered heating subgrade further comprises a heat preservation material layer disposed on a slope of the subgrade.
